(19) United States
(12) Patent Application Publication
(10) Pub. No.: US 2017/0291117 A1
(43) Pub. Date: Oct. 12, 2017

(54) Asymmetric Toy Module and Combined Toy Set

(71) Applicant: HI-TECHPIA Technology (Shenzhen) Co., Ltd., Shenzhen (CN)

(72) Inventor: Heejin ROH, Seoul (KR)

(73) Assignee: HI-TECHPIA Technology (Shenzhen) Co., Ltd., Shenzhen (CN)

(21) Appl. No.: 15/511,850

(22) PCT Filed: Dec. 25, 2015
(86) PCT No.: PCT/CN2015/098843

§ 371 Date: Mar. 16, 2017

(30) Foreign Application Priority Data
Jan. 9, 2015 (CN) 201520014220X

(51) Int. Cl. A63H 33/08; F16B 5/01

(52) U.S. Cl. CPC A63H 33/08; F16B 5/01

(57) ABSTRACT

Disclosed is an asymmetric toy module, which comprises a sheet-shaped square module body. The front surface of the module body is provided with a first combining element. At least one side surface of the module body is provided with a second combining element combined with the first combining element. The second combining elements on at least two opposite side surfaces are arranged asymmetrically. A combined toy set comprises a plurality of the asymmetric toy modules and a plurality of connecting modules, wherein the second combining element of one of the asymmetric toy modules is combined with the first combining element of the other asymmetric toy module, and the two asymmetric toy modules can also be connected together through the connecting modules. The asymmetric toy module achieves presentation levels and can form various exquisite assembled structures through a simple and rapid combination of the modules, thereby having high flexibility.

### BACKGROUND OF THE INVENTION

### Technical Field

The present invention belongs to the technical field of toys, and more specifically, to an asymmetrical toy module and a combined toy set comprising the asymmetrical toy modules.

### Description of Related Art

With the rapid development of the toy market at present, freely combined toys are getting popular among children and parents, and many modular toys have applied for patent protection. For instance, the registered patent (No. 10-0957884) discloses a modular toy set and a connecting device for the axis and link frame-type combined toy set. The disclosed patent (No. 10-2012-0040064) introduces a link not requiring screws and a toy set using it for assembly. The registered patent (No. 10-1324698) discloses a device for LEGO modules which can change the combining angles between the LEGO modules, as well as LEGO modules and a LEGO module set using the device.

LEGO has introduced a multilateral combined toy set that can realize the assembly of individual combing elements and structures. With a wide range of presentation of the assembly, it is more frequently used for children's toys and educational toys, the toys also have become very popular among adults. This kind of combined toy set has plural-form cylindrical studs protruding from the upper plane and square hollow blocks or bricks, namely, the side of the pillar is combined to the hollow blocks at the bottom, so as to maintain various states of structures through the friction between the blocks.

This kind of pillar block-combined toy is basically formed by the blocks stacked one by one, and it is subjected to more limits at the presentation levels than the axis and link-frame-system assembly method, so usually more blocks are required for presentation. In addition, all structures of the axis and link frame system are connected with the axis and link frame, so that the extension in a simple form needs to be completed through the axis and the link frame system, which tends to cost too much time and effort.

### BRIEF SUMMARY OF THE INVENTION

The objective of the present invention is to provide an asymmetric toy module and a combined toy set comprising the asymmetric toy modules, so as to solve the technical problems of the pillar block-combined toy set mentioned above. Compared with the pillar block-combined toy set in the prior art, the present invention can present a variety of structures in a simple, rapid and exquisite way.

To achieve the objectives above, the present invention adopts the following technical solution:

an asymmetric toy module, which comprises a sheet-shaped square module body, wherein the front surface of the module body is provided with a first combining element, at least one side surface of the module body is provided with a second combining element combined with the first combining element, and the second combining elements on at least two opposite side surfaces are arranged asymmetrically.

Preferably, the first combining element of the asymmetric toy module is a large hole running through the module body, with a plurality of small holes running through the module body arranged around the large hole; the second combining element is a protrusion that can be inserted into the large hole, with a through-hole provided inside the protrusion along the direction of the long or short axis thereof.

Preferably, the large holes are of a circular shape and equidistantly arranged, and the gap distances between the large holes, the centers of which are in the same straight line, remain the same; the small circular and irregular holes are arranged around the large holes and alternately arranged in a square shape, wherein the small circular holes are located at the corners of the square; the protrusions are of a cylindrical shape and arranged in the center line of the side surface of the module body and perpendicular to the side surface of the module body thereof.

Preferably, an even number of cylindrical protrusions are arranged on one side surface of the module body, and an odd number of cylindrical protrusions are arranged on the opposite side surface, with the gap distances between the cylindrical protrusions on the same side surface remaining the same.

Preferably, the gap distance between two adjacent cylindrical protrusions on the same side surface is twice as large as that between two adjacent large holes along the lateral direction of the module body.

A combined toy set comprises a plurality of the asymmetric toy modules, wherein the second combining element of one of the asymmetric toy modules is combined with the first combining element of the other asymmetric toy module.

Furthermore, the combined toy set further comprises a plurality of circular-angled square or L-like sheet-shaped connecting modules with right-angled corners, so that two asymmetrical toy modules can be connected together by means of the connecting modules.

Preferably, the width of the connecting module is equal to the thickness of the module body of the asymmetric toy module.

Preferably, the front surface of the connecting module is provided with the first combining element running through the connecting module, and the small circular holes running through the connecting module are arranged between two adjacent first combining elements.

Compared with the prior art, the beneficial effects of the present invention are as below:

The front surface of the asymmetric toy module in the present invention is provided with the first combining element, and its side surface is provided with the second combining element, with the second combining elements on two opposite side surfaces arranged asymmetrically, wherein the second combining element of one asymmetric toy module is inserted into the first combining element of the other asymmetric toy module, making the two asymmetric toy modules assembled together. The present invention of the combined toy set comprises a plurality of the asymmetric toy modules and the connecting modules, and two asymmetric toy modules can also be assembled together by means of the connecting module. Obviously, compared with the pillar module-combined toy set in the prior art, the present invention of the combined toy set can present more free and exquisite combined structures; in addition, the present invention gives more advantages to the pillar module-combined toy set, so that simple structures can be assembled through a more simple and rapid combination.

### BRIEF DESCRIPTION OF THE SEVERAL VIEWS OF THE DRAWINGS

FIG. 1 is a structural diagram of the asymmetric toy module in Embodiment 1;

FIG. 2 is a structural diagram of the asymmetric toy module in Embodiment 2;

FIG. 3 is a structural diagram of the asymmetric toy module in Embodiment 3;

FIG. 4 is a structural diagram of the connecting module;

FIG. 5 is a diagram of the connecting relation between a plurality of the asymmetric toy modules; and

FIG. 6 is a diagram of the connecting relation between two asymmetric toy modules that constitute a right-angled corner.

Description of marks in the drawings: 1. large hole; 2, small hole; 3. protrusion; 4. through-hole.

### DETAILED DESCRIPTION OF THE INVENTION

To facilitate the understanding of the objective, the technical solution and the effect thereof, the present invention is further detailed in combination with the embodiments as follows.

### Embodiment 1

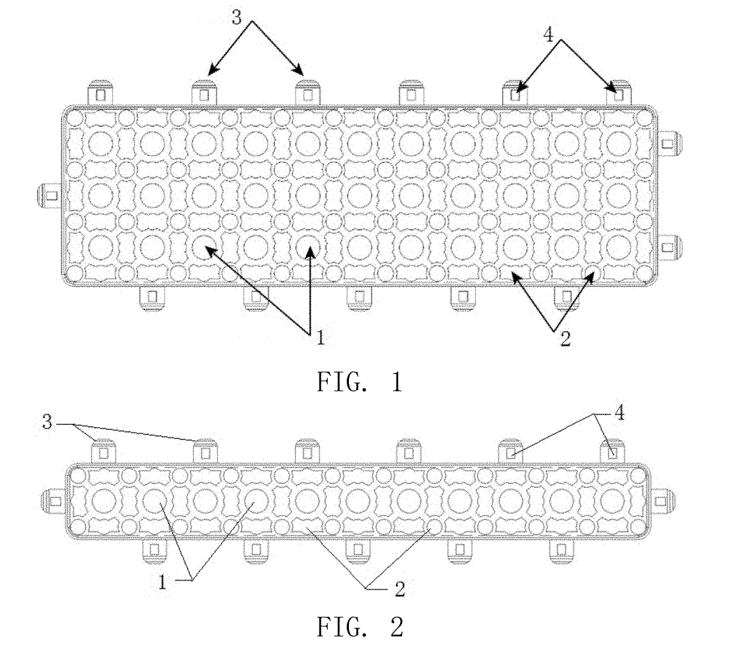

This embodiment provides an asymmetrical toy module, with its structure as shown in FIG. 1. The module body of an asymmetric toy module is a sheet-shaped rectangle; the front surfaces (upper and lower surfaces with larger area) of the module body are evenly arranged with first combining elements and at least one side surface of the module body is provided with second combining elements which can be inserted into the first combining elements, so that they can be connected together through the friction between each other. It shall be noted that the second combining elements on at least two opposite side surfaces are arranged asymmetrically.

As a preferable embodiment, the first combining elements are large circular holes 1 running through the module body; the large holes 1 are equidistantly arranged on the front surface of the module body and the gap distances between the large holes 1 located in the same straight line remain the same. As shown in FIG. 1, three parallel rows of the large holes 1 are arranged along the length-wise direction of the module body, with each row having 11 large holes 1. Four small circular holes 2 and four small irregular holes 2 are arranged around each large hole 1, wherein the small circular holes 2 and the small irregular holes 2 are alternatively arranged with their centers connected to form a square, and the small circular holes 2 are located at the four corners of the square.

The second combining element is a cylindrical protrusion 3 which can be inserted into the large hole 1, and a through-hole 4 is arranged inside the protrusion 3 along the direction of the long or short axis thereof. Particularly, the protrusions 3 are arranged at intervals in the center line of the side surface of the module body and perpendicular to the side surface of the module body thereof. As shown in FIG. 1, six cylindrical protrusions 3 are arranged on one side surface along the length-wise direction of the module body, and five cylindrical protrusions 3 are arranged on the opposite side surface, with the gap distances between the cylindrical protrusions on the same side surface remaining the same. Particularly, the gap distance between two adjacent cylindrical protrusions 3 on the same side surface is twice as large as that between two adjacent large holes 1 along the lateral direction of the module body.

### Embodiment 2

As shown in FIG. 2, this embodiment gives an asymmetric toy module of a long bar shape. The front surface of the module body is only arranged with one row of the large circular holes 1. Particularly, each of two opposite side surfaces along the width-wise direction of the module body is provided with a cylindrical protrusion 3, with the rest of the structure remaining the same as the asymmetric toy module described in Embodiment 1.

### Embodiment 3

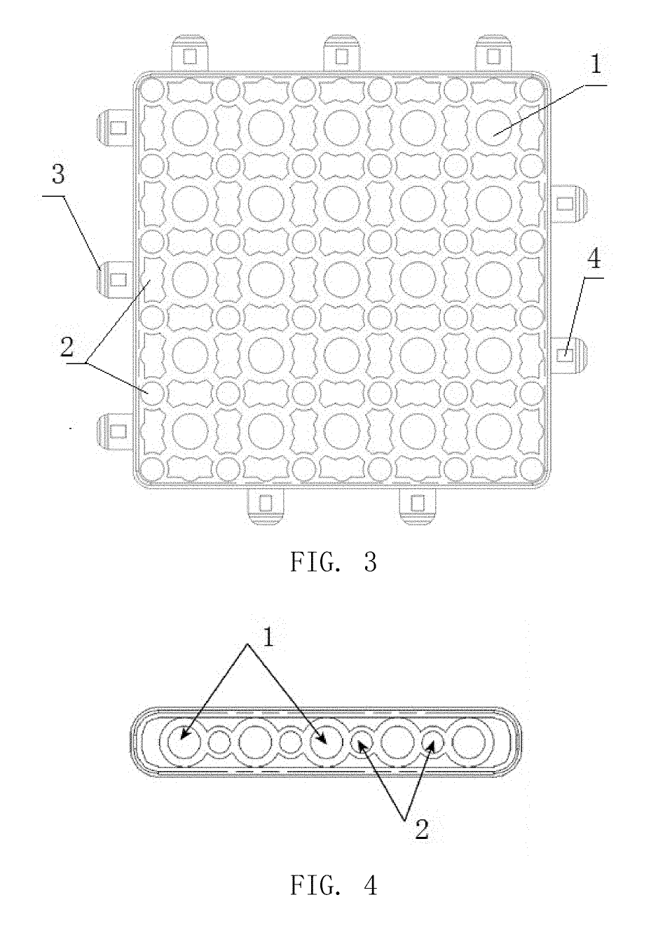

As shown in FIG. 3, this embodiment gives an asymmetric toy module of a square shape. Three cylindrical protrusions 3 are equidistantly arranged on each of the two adjacent side surfaces of the module body, and two cylindrical protrusions 3 are equidistantly arranged on each of the other two side surfaces. The front surface of the module body is evenly arranged with 25 large circular holes 1. The rest of the structure of the asymmetrical toy module described in this embodiment remains the same as the asymmetric toy module in Embodiment 1.

### Embodiment 4

This embodiment introduces a combined toy set, comprising any of the asymmetric toy modules described in Embodiment 1, Embodiment 2 and Embodiment 3, wherein the second combining element of one of the asymmetric toy modules is combined with the first combining element of the other asymmetric toy module. Furthermore, the combined toy set further comprises a plurality of circular-angled square or L-like sheet-shaped connecting modules with right-angled corners, so that two asymmetrical toy modules can be connected together by means of the connecting modules.

As shown in FIG. 4, the given connecting module is of a circular-angled square sheet-shaped structure, and the front surface of the connecting module is provided with first combining elements running through the connecting module: the first combining elements are preferably large circular holes 1 and small circular holes 2 running through the connecting module are arranged between two adjacent large holes 1. Particularly, the width of the connecting module is equal to the thickness of the module body of the asymmetric toy module.

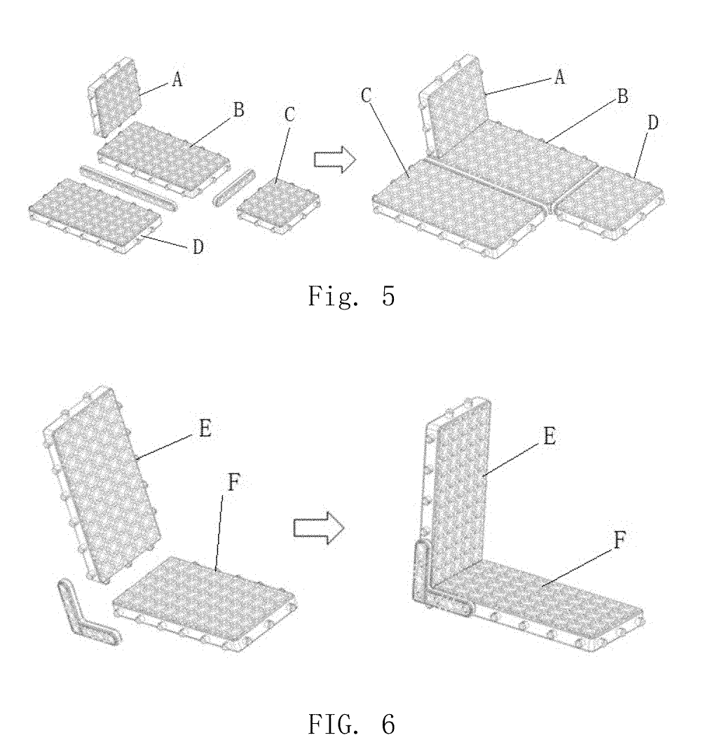

When a plurality of the asymmetric toy modules are to be assembled together, as shown in FIG. 5, the cylindrical protrusion 3 of the asymmetric toy module A is inserted into the large circular hole 1 of the other asymmetric toy module B, so that the asymmetric toy module A and the asymmetric toy module B can be connected perpendicularly. The cylindrical protrusions 3 on two side surfaces of the asymmetric toy module B are respectively connected with the asymmetric toy module C and the asymmetric toy module D through a circular-angled square sheet-shaped connecting module, thus making the asymmetric toy module B located in the same plane with the asymmetric toy module C and the asymmetric toy module D.

The two asymmetrical toy modules can also be connected perpendicularly by means of an L-like sheet-shaped connecting module with right-angled corners, as shown in FIG. 6. The cylindrical protrusion 3 of the asymmetric toy module E is closely attached with one side surface of the asymmetric toy module F instead of being inserted directly into the large circular hole 1 of the asymmetric toy module F, namely, the asymmetric toy module E and the side surface of the asymmetric toy module F are connected together by means of an L-like sheet-shaped connecting module with right-angled corners.

The above-mentioned embodiments are intended to give further details about the present invention, but not to limit the present invention, so those skilled in the art could make various modifications within their range of knowledge, without deviating from the principle of the present invention.

1. An asymmetric toy module, comprising a sheet-shaped square module body, characterized in that the front surface of the module body is provided with a first combining element, at least one side surface of the module body is provided with a second combining element combined with the first combining element, and the second combining elements on at least two opposite side surfaces are arranged asymmetrically.

2. The asymmetric toy module as claimed in claim 1, characterized in that the first combining element of the asymmetric toy module is a large hole running through the module body, with a plurality of small holes running through the module body arranged around the large hole; the second combining element is a protrusion that can be inserted into the large hole, with a through-hole provided inside the protrusion along the direction of the long or short axis thereof.

3. The asymmetric toy module as claimed in claim 2, characterized in that the large holes are of a circular shape and equidistantly arranged, and the gap distances between the large holes, the centers of which are in the same straight line, remain the same; four small circular holes and four small irregular holes are arranged around the large holes and alternately arranged in a square shape, wherein the small circular holes are located at the corners of the square; the protrusions are of a cylindrical shape and arranged in the center line of the side surface of the module body and perpendicular to the side surface of the module body thereof.

4. The asymmetric toy module as claimed in claim 3, characterized in that an even number of cylindrical protrusions are arranged on one side surface of the module body, and an odd number of cylindrical protrusions are arranged on the opposite side surface, with the gap distances between the cylindrical protrusions on the same side surface remaining the same.

5. The asymmetric toy module as claimed in claim 4, characterized in that the gap distance between two adjacent cylindrical protrusions on the same side surface is twice as large as that between two adjacent large holes along the lateral direction of the module body.

6. A combined toy set comprising at least two asymmetric toys module as claimed in claim 1, wherein the second combining element of one of the asymmetric toy modules is combined with the first combining element of the other asymmetric toy module.

7. The combined toy set as claimed in claim 6, characterized in that, further comprising a plurality of circular-angled square or L-like sheet-shaped connecting modules with right-angled corners, so that two asymmetrical toy modules can be connected together by means of the connecting modules.

8. The combined toy set as claimed in claim 7, characterized in that the width of the connecting module is equal to the thickness of the module body of the asymmetric toy module.

9. The combined toy set as claimed in claim 8, characterized in that the front surface of the connecting module is provided with the first combining element running through the connecting module, and the small circular holes running through the connecting module are arranged between two adjacent first combining elements.
